(19) United States
(12) Patent Application Publication
(10) Pub. No.: US 2013/0064563 A1
(43) Pub. Date: Mar. 14, 2013

(54) IMAGE FORMING APPARATUS

(71) Applicant: Kenichi Shibuya, Toride-shi (JP)

(72) Inventor: Kenichi Shibuya, Toride-shi (JP)

(73) Assignee: CANON KABUSHIKI KAISHA, Tokyo (JP)

(21) Appl. No.: 13/606,254

(22) Filed: Sep. 7, 2012

(30) Foreign Application Priority Data
Sep. 9, 2011 (JP) 2011-197704

(51) Int. Cl. G03G 15/02

(52) U.S. Cl. 399/50

(57) ABSTRACT

An image forming apparatus includes photosensitive members, charging members supplied with charging voltages each comprising a component of a DC voltage and a component of an AC voltage, AC current measuring devices for measuring AC currents flowing into charging members, and control means for controlling peak-to-peak voltages of the AC voltages, wherein the control means calculates peak-to-peak voltages of the AC voltages required to provide a predetermined discharge current, from results of the measurements of the AC current measuring devices, and determines a maximum value of the required peak-to-peak voltages as a target value of a constant-voltage-control of the AC voltage in an image forming operation.

### FIELD OF THE INVENTION AND RELATED ART

The present invention relates to an image forming apparatus such as an electrophotographic type copying machine, printer or facsimile machine.

A tandem type electrophotographic type image forming apparatus is known in which image forming stations having respective photosensitive members are arranged in line along a moving direction of a recording material carrying member or an intermediary transfer member. The image forming stations of the tandem type image forming apparatus include yellow, magenta, cyan and black image forming stations, for example, toner images formed on the photosensitive members of the image forming stations are sequentially transferred onto the recording material or an intermediary transfer member carried on the recording material carrying member, superimposedly. In each image forming station, the surface of the photosensitive member is charged uniformly, and thereafter, it is exposed to light in accordance with image information so that an electrostatic latent image is formed on the photosensitive member. The electrostatic latent image is developed with toner into a toner image on the photosensitive member.

As for charging means for charging the surface of the photosensitive member, there are non-contact charging devices such as a corotron or scorotron. As for another type charging means, there is a non-contact type or proximity type (called hereinafter simply “contact type” charging member such as or a charging roller a charging brush to which a voltage is applied, the charging roller and the charging brush being disposed in proximity with and in contact with the surface of the photosensitive member. The contact charging device is advantageous over the non-contact type charging device in that the voltage of the voltage source can be reduced and in that the generation amount of the ozone is small.

On the other hand, with the contact type charging device, the charging voltage readily changes by variation of the properties of the charging member or by change in the temperature and/or humidity. In order to suppress the readiness, an AC charging type is used in which an oscillating voltage having a DC voltage (charging DC voltage) component and an AC voltage component (charging AC voltage) is applied to the charging member.

In the AC charging type, there is a proper range in the peak-to-peak voltage of the charging AC voltage (charging AC voltage) component. If the charging AC voltage is too low, the photosensitive member is not charged up to a desired potential or the charging of the photosensitive member is not uniform with the result that sandpaper like background or foggy background (deposition of the toner on the non-image portion on which the toner is not to be deposited) is produced. If the charging AC voltage is too high, the wearing (scraping) of the photosensitive member is promoted with the result of less durability.

In addition, with the contact type charging device employing the AC charging system, the wearing of the photosensitive member is larger than with the non-contact type such as the corotron or scorotron. The wearing of the photosensitive member is promoted with increase of the charging AC voltage. Therefore, it is desired to reduce the charging AC voltage in order to reduce the wearing of the photosensitive member.

On the other hand, because of the existence of the minimum charging AC voltage (Vmin) necessary for uniformly charging the photosensitive member, and therefore, the AC charging type charging device does not work with the charging AC voltage not higher than the minimum level. It is known that the minimum charging AC voltage is substantially twice the voltage (discharge starting voltage) at which the discharge starts between the charging member and the photosensitive member when only a DC voltage is applied to the charging member and is gradually increased (Japanese Laid-open Patent Application Sho 63-149668). however, the required minimum charging AC voltage changes with the properties of the charging member, the photosensitive member or a voltage source circuit, depending on the difference among individuals, ambient condition change, and with elapsed time.

It is known that a discharge current flowing into the photosensitive member from the charging member to contribute the charging of the photosensitive member is determined, and the control is carried out to maintain the discharge current constant (discharge current control) (Japanese Laid-open Patent Application 2001-201921). A function of the flowing AC current relative to the applied charging AC voltage in the unchanging region is determined. In addition, a function of the flowing AC current relative to an applied charging AC voltage in the discharge range is determined. The discharge current is calculated as a difference between the functions to determine the required charging AC voltage or AC current thereby to control the charging bias voltage.

As described above, in the AC charging type, it is desirable to apply a charging AC voltage within the proper range.

However, in the tandem type image forming apparatus, if the image forming stations are provided with respective AC voltage sources to apply the charging AC voltages within the proper ranges to the charging member of the image forming stations, respectively, the number of the voltage sources is large. If the number of the voltage sources increases, the device is upsized, and the weight thereof increases with the result of cost increase.

### SUMMARY OF THE INVENTION

Accordingly, it is an object of the present invention to provide an image forming apparatus comprising a plurality of image forming stations each having respective charging members which are supplied with AC voltages from a common voltage source, in which necessary sufficient discharge currents are provided for respective image forming stations.

According to an aspect of the present invention, there is provided an image forming apparatus comprising a plurality of photosensitive members; a plurality of charging members, provided for said photosensitive members, respectively, for electrically charging said photosensitive members by being supplied with charging voltages each comprising a component of a DC voltage and a component of an AC voltage; an AC voltage source for outputting an AC voltage commonly applied to at least two of said charging members; AC current measuring devices for measuring AC currents flowing into said at least two charging members, respectively; and control means for controlling peak-to-peak voltages of the AC voltages applied to said at least two charging members from said AC voltage source, wherein said control means calculates peak-to-peak voltages of the AC voltages required to provide a predetermined discharge current, from results of the measurements of said AC current measuring devices, and determines a maximum value of the required peak-to-peak voltages as a target value of a constant-voltage-control of the AC voltage applied to at least two charging members from said AC voltage source in an image forming operation.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic illustration of an image forming apparatus according to an embodiment of the present invention.

FIG. 2 is a schematic sectional view illustrating detailed structure around a charging roller of the image forming apparatus according to the embodiment of the present invention.

FIG. 3 is an operation sequence diagram of the image forming apparatus according to the embodiment of the present invention.

FIG. 4 is an illustration of a control method for a charging AC voltage of the image forming apparatus according to the embodiment of the present invention.

FIG. 5 is an illustration of a control method for a charging AC voltage of the image forming apparatus according to the embodiment of the present invention.

FIG. 6 is an illustration of a control method for a charging AC voltage of the image forming apparatus according to the embodiment of the present invention.

FIG. 7 is a graph of an example of Vpp−Iac in a color image formation portion the image forming apparatus according to the embodiment of the present invention.

FIG. 8 is a flow chart showing a process of the control method for the charging AC voltage in the image forming apparatus according to the embodiment of the present invention.

FIG. 9 is an illustration of a control method for a charging AC voltage of the image forming apparatus according to the embodiment of the present invention.

FIG. 10 is an illustration of a control method for a charging AC voltage of the image forming apparatus according to the embodiment of the present invention.

FIG. 11 is a graph of an example of Vpp−Iac in a color image formation portion the image forming apparatus according to another embodiment of the present invention.

FIG. 12 is a flow chart showing a process of the control method for the charging AC voltage in the image forming apparatus according to another embodiment of the present invention.

FIG. 13 is a graph of an example of Vpp−Iac in a color image formation portion the image forming apparatus according to another embodiment of the present invention.

FIG. 14 is a flow chart showing a process of the control method for the charging AC voltage in the image forming apparatus according to another embodiment of the present invention.

FIG. 15 is a block diagram illustrating a control manner for an operating portion in the image forming apparatus according to a further embodiment.

FIG. 16 is a schematic view of an example of the operating portion according to a further embodiment.

FIG. 17 is a flow chart showing a process of the control method for the charging AC voltage in the image forming apparatus according to another embodiment of the present invention.

### DESCRIPTION OF THE PREFERRED EMBODIMENTS

### Embodiment 1

### 1. General Arrangement and Operation of Image Forming Apparatus

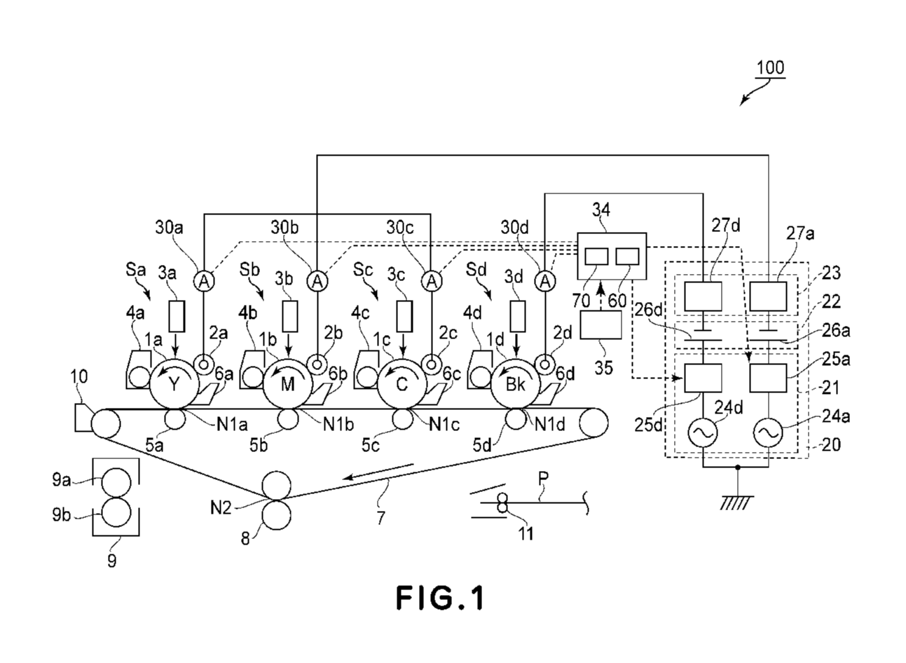

FIG. 1 show a general arrangement of an image forming apparatus 100 according to Embodiment 1 of the present invention. The image forming apparatus 100 according to this embodiment is a tandem type full-color image forming apparatus using an electrophotographic system.

The image forming apparatus 100 comprises a plurality of image forming stations, namely, first, second, third and fourth image forming stations Sa, Sb, Sc, Sd for forming yellow (Y), magenta (M), cyan (C) and black (Bk) images. Such four image forming stations Sa, Sb, Sc, Sd are arranged in line at constant intervals along a moving direction of an image carrying surface of an intermediary transfer member as a transfer member which will be described hereinafter in detail. In this embodiment, a voltage source is common for the first, second and third image forming stations Sa, Sb, Sc to apply the voltages to the charging members therein.

In this embodiment, the structures and operations of the first, second, third and fourth image forming stations Sa, Sb, Sc, Sd are substantially the same except for the developers therein. Therefore, unless reference is to be made to particular ones, the suffixes a, b, c and d are omitted to indicate that reference is made to each of the elements of any of the image forming stations.

The image forming station S includes a drum type electrophotographic photosensitive member (photosensitive member), that is, photosensitive drum 1 as an image bearing member. Around the photosensitive drum 1, the following means are provided. The first one is a roller type charging member, that is, a charging roller 2 as a contact type charging means. The second is an exposure device (laser scanner) 3 as exposure means. The third is a developing device 4 as developing means. The fourth is a primary transfer roller 5 which is a roller type primary transfer member as primary transferring means. The fifth is a drum cleaning device 6 as photosensitive member cleaning means. The charging roller 2 rotates in contact with the surface of the photosensitive drum 1. The developing device 4a, 4b, 4c, 4d accommodate yellow toner, magenta toner, cyan toner and black toner, respectively. The drum cleaning device 6 includes a cleaning blade as a cleaning member, and the cleaning blade contacts the photosensitive drum 1 to scrape the toner off the surface of the rotating photosensitive drum 1.

The apparatus further comprises an intermediary transfer belt 7 in the form of an endless belt as an intermediary transfer member which is opposed to the photosensitive drum 1 in the image forming station S. The intermediary transfer belt 7 is stretched around a plurality of rollers with a predetermined tension. The primary transfer roller 5 is opposed to the photosensitive drum 1 of the image forming station S in the inside of the intermediary transfer belt 7. The primary transfer roller 5 is urged toward the photosensitive drum 1 with the intermediary transfer belt 7 therebetween to constitute a primary transfer portion (primary transfer nip) N1 where the photosensitive drum 1 and the intermediary transfer belt 7 are contacted with each other. To the outer surface of the intermediary transfer belt 7, a secondary transfer roller 8 which is a roller type secondary transfer member as secondary transferring means is provided at a position opposed to one of the rollers supporting the intermediary transfer belt 7. The secondary transfer roller 8 is urged toward said one of the rollers with the intermediary transfer belt 7 interposed therebetween to constitute a secondary transfer portion the secondary transfer nip) N2 where said secondary transfer roller 8 and said intermediary transfer belt 7 are contacted with each other.

Image forming operations will be described with an example in which a full-color image is formed on a recording material P. First, in each image forming station S, the photosensitive drum 1 is charged uniformly by the charging roller 2. The charging voltage applying means will be described hereinafter. The surface of the charged photosensitive drum 1 is exposed to scanning light in accordance with image information by an exposure device 3. By this, an electrostatic latent image (electrostatic image) is formed on the photosensitive drum 1. The electrostatic latent image formed on the photosensitive drum 1 is developed with the toner by the developing device 4. By this, a toner image is formed on the photosensitive drum 1. In this embodiment, the toner image is formed by the image exposure and a reverse development. That is, the photosensitive drum 1 is charged uniformly and is exposed by the exposure device 3 to decrease in the absolute value of the potential at an image portion, to which the toner charged to the polarity the same as the charge polarity of the photosensitive drum 1 (negative polarity, in this embodiment) is deposited.

The color toner images thus formed on the photosensitive drum 1 of the image forming stations S are transferred (primary transfer) sequentially and imposedly onto the intermediary transfer belt 7 by the primary transfer rollers 5 in the primary transfer portions N1. At this time, the primary transfer roller 5 is supplied with a primary transfer voltage (primary transfer bias) of the polarity opposite to the regular charge polarity (negative in this embodiment) of the toner from a primary transfer voltage source (unshown) as a primary transfer voltage applying means. The toner images transferred onto the intermediary transfer belt is transferred (secondary transfer) onto the recording material P by the function of the secondary transfer roller 8 in the secondary transfer portion N2 (secondary transfer). At this time, the secondary transfer roller 8 is supplied with the secondary transfer voltage (secondary transfer bias voltage) of the polarity opposite to the regular charge polarity (negative in this embodiment) of the toner from a secondary transfer voltage source (unshown) as secondary transfer voltage applying means. The recording material P is fed from a recording material accommodating cassette (unshown) or the like to the secondary transfer portion N2 by a supplying roller 11 or the like. The recording material P having the transferred toner image is separated from the intermediary transfer belt 7 and is fed to a fixing device 9 as fixing means. The recording material P passes through a nip (fixing nip) between a fixing roller 9a and a pressing roller 9b of the fixing device 9, during which the toner image is heated and pressed thereby to be fixed. Thereafter, the recording material P is discharged to the outside of the image forming apparatus 100.

The toner (primary-untransferred toner) remaining on the photosensitive drum 1 after the primary transfer step is removed from the photosensitive drum 1 and is collected by the drum cleaning device 6. The residual toner (after-secondary-transfer) remaining on the intermediary transfer belt 7 after the secondary transfer step is removed and collected from the intermediary transfer belt 7 by a belt cleaning device 10 as intermediary transfer member cleaning means.

### 2. Charging Voltage Source Circuit.

The charging rollers 2 of the image forming stations S are supplied with charging voltages (charging bias voltages) from a charging voltage source circuit 20 as charging voltage applying means. By doing so, the surfaces of the photosensitive drums 1 are charged uniformly to predetermined potentials.

The charging voltage source circuit 20 includes an AC voltage source portion 21, a DC voltage source portion 22 and a DC amplification portion 23. Using them, the charging voltage source circuit 20 generates an oscillating voltage which is in the form of superimposed DC voltage (charging DC voltage) and AC voltage (charging AC voltage), as the charging voltage to be applied to the charging rollers 2. In this embodiment, the charging voltage source circuit 20 includes respective voltage source circuit elements for the fourth image forming station Sd (black image forming station) and the color image formation portions Sa, Sb, Sc (first, second and third image forming stations). This is because, generally speaking, the frequencies of usage of the color image formation portions Sa, Sb, Sc and the black image forming station Sd are different from each other, and therefore, the deterioration speeds of the member the such as the photosensitive drum 1 are, in many cases, different with the result of different required discharge current which will be described hereinafter in detail. In this embodiment, each of the DC voltage and the AC voltage are common to all of the color image formation portions Sa, Sb, Sc. For the black image forming station Sd, a different DC voltage source and a different AC voltage source are provided.

The charging rollers 2a, 2b, 2c of the color image formation portions Sa, Sb, Sc are supplied with the DC voltages from a first DC voltage source (DC voltage generating circuit) 26a in the DC voltage source portion 22. The value of the DC voltage value is adjusted by a first DC amplification circuit 27a in the DC amplification portion 23. The charging rollers 2a, 2b, 2c of the color image formation portions Sa, Sb, Sc are supplied with the AC voltage from a first AC voltage source (AC voltage generating circuit) 24a in the AC voltage source portion 21. The value of the AC voltage is adjusted by a first AC amplifying circuit 25a in the AC voltage source portion 21.

On the other hand, the charging roller 2d of the black image forming station Sd is supplied with the DC voltage from a second DC voltage source (DC voltage generating circuit) 26d in the DC voltage source portion 22. The value of the DC voltage value is adjusted by a second DC amplification circuit 27d in the DC amplification portion 23. The charging roller 2d of the black image forming station Sd is supplied with the AC voltage from the second AC voltage source (AC voltage generating circuit) 24d in the AC voltage source portion 21. The value of the AC voltage is adjusted by a second AC amplifying circuit 25d in the AC voltage source portion 21.

charging AC currents which are the values of the AC currents flowing into the charging rollers 2a, 2b, 2c, 2d are measured by AC current measuring devices 30a, 30b, 30c, 30d as AC current measuring means, respectively. For example, a relationship between the applied charging AC voltage Vpp obtained by raising and dropping the charging AC voltage by the first and second AC amplifying circuits 25a, 25b and the measured charging AC current Iac is calculated by a control circuit 34. The relation is used in order to determine the charging AC voltage for providing the required discharge current (charging AC current in Embodiment 2 which will be described hereinafter).

In this embodiment, a frequency of an output of the AC voltage source portion 21 is 1.5 kHz. In this embodiment, the charging DC voltage is approx. −500V. In this embodiment, a charged potential of the photosensitive drum 1 converges uniformly to the charging DC voltage substantially.

3. Structures around Charging Roller:

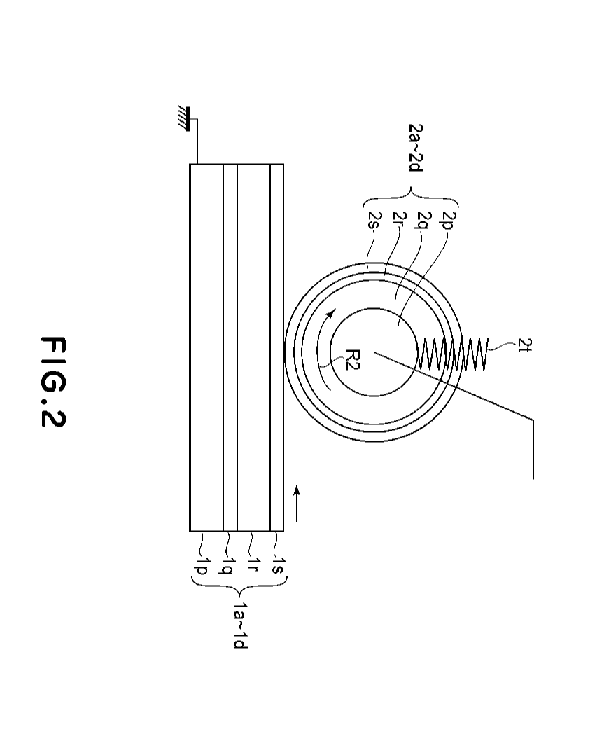

In this embodiment, the photosensitive drum 1 includes an organic photosensitive member (OPC) having a negative charging property and having an outer diameter of 30 mm. As shown in FIG. 2, the photosensitive drum 1 comprises an aluminum cylinder (electroconductive drum base member) 1p, and three layers therein including an undercoat layer 1q thereon for suppressing interference of the light and improving an adhesiveness with the upper layer, a photocharge generation layer 1r and a charge transfer layer 1s, in this order from the bottom. As shown in FIG. 2, the photosensitive drum 1 comprises an aluminum cylinder (electroconductive drum base member) 1p, and three layers therein including an undercoat layer 1q thereon for suppressing interference of the light and improving an adhesiveness with the upper layer, a photocharge generation layer 1r and a charge transfer layer 1s, in this order from the bottom. In this embodiment, a thickness of the charge transfer layer is 28 μm, and when it is worn down to 13 μm, a problem or the like improper charging arises.

In this embodiment, a length of the charging roller 2 (rotational axis direction) is 320 mm. As shown in FIG. 2, the charging roller 2 comprises a core metal (supporting member) 2p and there layers thereon including a lower layer 2q, the middle layer 2r and a surface layer 2s, in this order from the bottom. The lower layer 2q is a foam sponge layer effective to reduce charging noise, and the surface layer 2s is a protection layer for preventing current leakage which occurs if the photosensitive drum 1 has a pin hole or the like.

More specifically, the specifications of the charging roller 2 in this embodiment are as follows:

Core metal 2p; stainless steel round bar of diameter of 6 mm:

Lower layer 2q; carbon dispersed EPDM bubble generation having a density of 0.5 g/cm̂3, a volume resistivity of 10̂2-10̂9 Ωcm and a layer thickness of 3.0 mm.

Middle layer 2r; carbon dispersed NBR rubber having a volume resistivity of 10̂2-10̂5 Ωcm and a layer thickness of 700 μm.

Surface layer 2s; tin oxide and carbon dispersed fluorine compound resin material having a volume resistivity of 10̂7-10̂10 Ωcm and a surface roughness (JIS 10 point average surface roughness Ra) of 1.5 μm and having a layer thickness of 10 μm.

The charging roller 2 is urged toward the center of the photosensitive drum 1 by an urging spring 2t as urging means to be press-contacted to the surface of the photosensitive drum 1 at a predetermined pressure. The charging roller 2 is rotated by the photosensitive drum 1. A press-contact portion between the photosensitive drum 1 and the charging roller 2 is a charging nip. In this embodiment, an overall volume resistivity of the charging roller 2 is 1.0×10̂5 Ωcm.

Here, in a contact type charging device, the charging member is not necessarily contacted to the surface of the photosensitive member. If only the dischargeable region determined by a voltage across the gap and a corrected Paschen curve is assured between the charging member and the photosensitive member, they may be spaced by several 10 μm, for example (non-contact proximity arrangement). Therefore, in this invention, the contact charging includes such proximity charging.

### 4. Operational Sequence of Image Forming Apparatus:

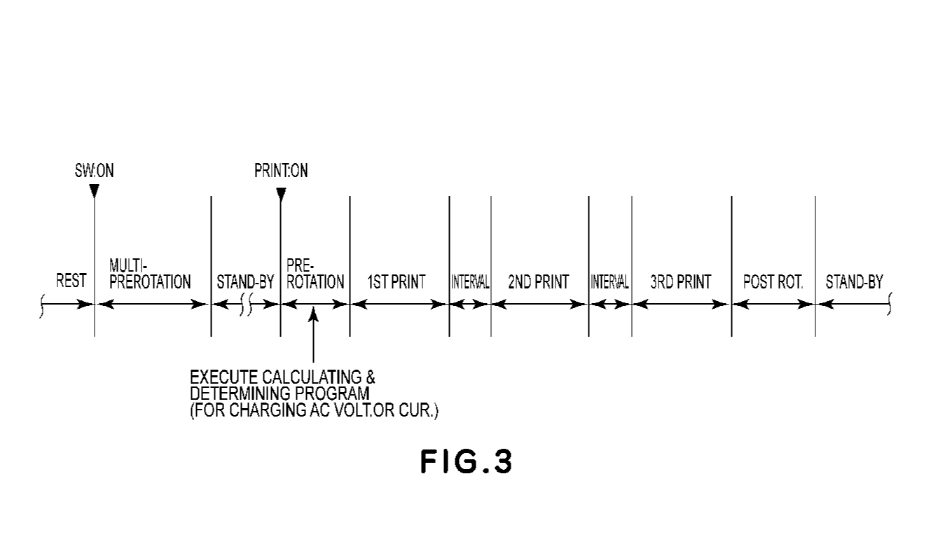

FIG. 3 shows an operational sequence of the image forming apparatus 100 in this embodiment.

### A. Initial Rotating Operation (Multiple-Pre-Rotation Step):

An initial rotating operation is carried out during a starting operation period (starting operation period or warming period) at the time of starting the image forming apparatus 100. In the initial rotating operation, upon actuation of a main switch of the image forming apparatus 100, the photosensitive drum 1 is rotated, the fixing device 9 is heated to a predetermined temperature, and other predetermined preparing operations for the process means are executed.

### B. Rotating Operation for Printing Preparation (Pre-Rotation Step):

The rotating operation for the printing preparation is carried out after the input of a printing signal (image formation start signal) before the printing step (image forming process) is actually executed (preparation rotating operation period). The rotating operation for the printing preparation is carried out continuing from the initial rotating operation, when the printing signal is inputted during the initial rotating operation. When the printing signal is not inputted, the main motor is once stopped after completion of the initial rotating operation so that the rotation of the photosensitive drum 1 is stopped, and the image forming apparatus 100 is placed in a stand-by (waiting) state until the printing signal is inputted. When the printing signal is inputted, the rotating operation for the printing preparation is carried out.

In this embodiment, during the rotating operation for the printing preparation, a calculation and determination program for the appropriate charging AC voltage (charging AC current in Embodiment 2) for the charging step is executed. This will be described detail hereinafter.

### C. Printing Step (Image Forming Process, Image Forming Step):

When the predetermined rotating operation for the printing preparation is completed, the image formation process is carried out on the continuously rotating photosensitive drum 1, and the toner image formed on the surface of the rotating photosensitive drum is transferred to the recording material P, and the toner image is fixed by the fixing device 9. Then, a print is discharged (print-out) to the outside of the image forming apparatus 100.

In the case of continuous printing, the printing step is carried out repetitively for the set number of image formations.

D. Operation between Sheets Processed (Sheet Interval Step):

This operation is carried out, in the case of the continuous printing operation, during the period after a trailing end of a recording material P passes through the transfer position (secondary transfer portion N2) and before a leading end of the next recording material P reaches the transfer position, that is, the recording material P is not present in the transfer position.

### E. Post-Rotating Operation:

The post-rotating operation is carried out after completion of the printing step on a single recording material P or after completion of the printing step on the final recording material P in the continuous printing. During the post-rotating operation, that is, the main motor continues to drive to rotate while carrying out predetermined finishing operations (preparing operation for the next image forming operation) in such periods.

### Stand-By:

When the predetermined post-rotating operation is completed, the main motor is stopped to stop the rotation of the photosensitive drum 1, and the image forming apparatus 100 is placed in the stand-by state until the next printing signal is inputted. In the case of a single print operation, after completion of the print, the post-rotating operation is carried out, and the image forming apparatus 100 is placed in the stand-by state. In the stand-by state, when the printing signal is inputted, the image forming apparatus 100 carries out the pre-rotation step.

The printing step period in above section c is the image forming operation period, and the initial rotating operation period in above section a, the pre-rotating operation period in above section b, the sheet interval step period in the above section d and the post-rotating operation period are non-image-formation periods.

### 5. Controlling Manner:

The operation of the image forming apparatus 100 in this embodiment is controlled as a whole by the control circuit 34 provided in the image forming apparatus 100. As shown in FIG. 1, the control circuit 34 comprises a memory 60 as storing means for storing information, a CPU 70 as control means for instructing various operations of the image forming apparatus 100.

In this embodiment, there is provided an ambient condition sensor 35 as ambience detecting means in the image forming apparatus 100. In this embodiment, the ambient condition sensor 35 detects a relative humidity of the ambience in the image forming apparatus 100. The information of the humidity measured by the ambient condition sensor 35 is transmitted to the control circuit 34. Here, the relative humidity measured by the ambient condition sensor 35 is 50%.

To the control circuit 34, the humidity information of the ambience in the image forming apparatus 100 is transmitted from the ambient condition sensor 34, and the information of the AC current is transmitted from the AC current measuring device 30. The information is stored in the memory 60 if necessary. The CPU 70 controls various operations of the image forming apparatus 100 in accordance with the information stored in the memory 60.

### 6. Charging AC Voltage Control:

A method of controlling the charging AC voltage applied to the charging roller 2 during the printing step will be described.

It has been found that the discharge current digitized by the definition below represents the actual amount of discharge (AC discharge) by the application of the charging AC voltage and has a correlation with the scraping of the photosensitive member, the image flow and the uniform charging.

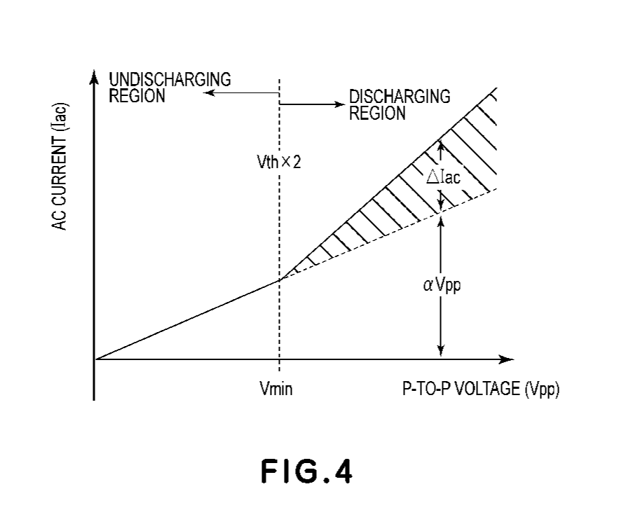

As shown in FIG. 4, the charging AC current Iac which is a value of the AC current flowing by the application of the charging AC voltage has the following relationship relative to the charging AC voltage Vpp which is a value of the peak-to-peak voltage of the charging AC voltage. That is, the relationship is linear by the un-discharging range in which the voltage is less than twice the discharge starting voltage (Vth×2: discharge start point). Here, the discharge starting voltage Vth is the voltage at which the discharge to the photosensitive member starts when a DC voltage is applied to the charging member. In the discharge range not less than Vth×2, the charging AC current Iac gradually offsets toward an increasing side with increase of the charging AC voltage Vpp. In similar experiments in vacuum in which no discharge occurs, the linearity is maintained, and therefore, the offset is the increment ΔIac of the current contributing to the discharge.

Here, a ratio of the charging AC current relative to the charging AC voltage Vpp in the un-discharging range less than Vth×2 is α. Then, the AC current which is the current flowing to the contact portion between the charging member and the photosensitive member (nip current) except for the discharge current at discharge range not less than Vth×2 is α·Vpp. Therefore, the following ΔIac which is a difference between the charging AC voltage Iac measured in the discharge range not less than Vth×2 and α·Vpp is defined as a discharge current representing the discharge amount provided by the application of the charging AC voltage:

ΔIac=Iac−α·Vpp (1).

With increase of the discharge current ΔIac, the wearing (scraping) or the image flow of the photosensitive member is promoted. The image flow is a phenomenon-in which the electric discharge product or the like ozone and/or NOx are deposited on the surface of the photosensitive member, and the deposited matter absorbs moisture under a high humidity ambience with the result of reduction of the charge retention performance of the surface of the photosensitive member, which leads to the disturbance to the image. When the discharge current ΔIac decreases, the image defect such as the foggy background and the sandpaper like background is produced. Therefore, in the AC charging type system, it is desirable that the settings are controlled such that the minimum discharge current capable of charging the photosensitive member uniformly is provided. By doing so, satisfactory images can be formed, and the scraping of the photosensitive member is minimized, thus elongating the lifetime of the image forming apparatus.

When the control is effected to control the charging AC voltage at a constant voltage, or to control the charging AC current at a constant current, the discharge current ΔIac changes with the ambient condition and/or a use amount of the photosensitive drum 1. This is because the relationship between the charging AC voltage and the discharge current and the relationship between the charging AC current and the discharge current vary.

In a known AC constant-current-control type, the control is effected on the basis of a total current from the charging member into the member to be charged. The total current is a sum of the α·Vpp and the discharge current ΔIac. Therefore, in the AC constant-current-control type, the control is based not only on the discharge current which is actual necessary for charging the photosensitive member but on such current plus the nip current. Therefore, the discharge current is not controlled, actually. In such an AC constant-current-control type, even if the same current is aimed, the discharge current decreases when the nip current increases due to the variation of the ambient condition or due to the increase of the use amount the electric resistance of the charging member, and the discharge current increases when the nip current decreases. For this reason, in such an AC constant-current-control type, the increase and/or decrease of the discharge current may be difficult. Then, accomplishment of both of the reduction of the wearing (scraping) of the photosensitive member and the uniform charging of the photosensitive member may be different, when expansion of the lifetime of the device is intended.

As described above, the discharge starting voltage Vth which determines the discharge start point (Vth×2) changes depending on the property of the photosensitive member (resistance, capacity, material or the like), the property of the charging member (resistance, capacity, material or the like), difference, among individuals, of the property of the voltage source circuit, ambient condition change, change with the elapsed time, for example. Therefore, it is difficult to determine correctly the discharge starting voltage Vth which determines the discharge start point (Vth×2). The relationship between the charging AC voltage Vpp and the charging AC current in the discharge region becomes nonlinear, because the charging AC current tends to increase as is distance from the discharge start point (Vth×2). Therefore, it is difficult to determine the discharge current ΔIac with high accuracy. Therefore, in the known AC constant-current-control type, the applied charging AC voltage is normally such that a charging AC current not less than the charging AC current which flows when the minimum charging AC voltage is applied. Or, for the same reason, a charging AC voltage not less than the minimum charging AC voltage is applied. In such a case, the wearing of the photosensitive member attributable to the excessive discharge may be a problem.

Under the circumstances, in this embodiment, the control is as follows in order to provide the necessary discharge current. The discharge current control in this embodiment will be described with respect to one image forming station, that is, one charging roller. A determination method of a charging AC voltage when a common AC voltage source is used for a plurality of image forming stations will be described in detail hereinafter.

Here, when the necessary discharge current is D, a charging AC voltage providing the discharge current D is determined.

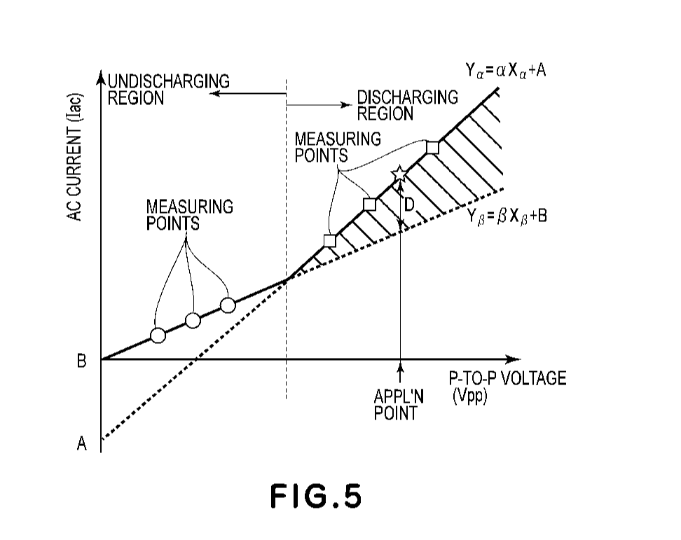

First, as shown in FIG. 5 a control circuit 34 controls an AC voltage circuit 21 to apply sequentially three charging AC voltages in the discharge range and three charging AC voltages in the un-discharging range. When These charging AC voltages are applied, the AC currents Iac flowing into the charging rollers 2 are measured by the associated AC current measuring devices 30, and are inputted to the control circuit 34.

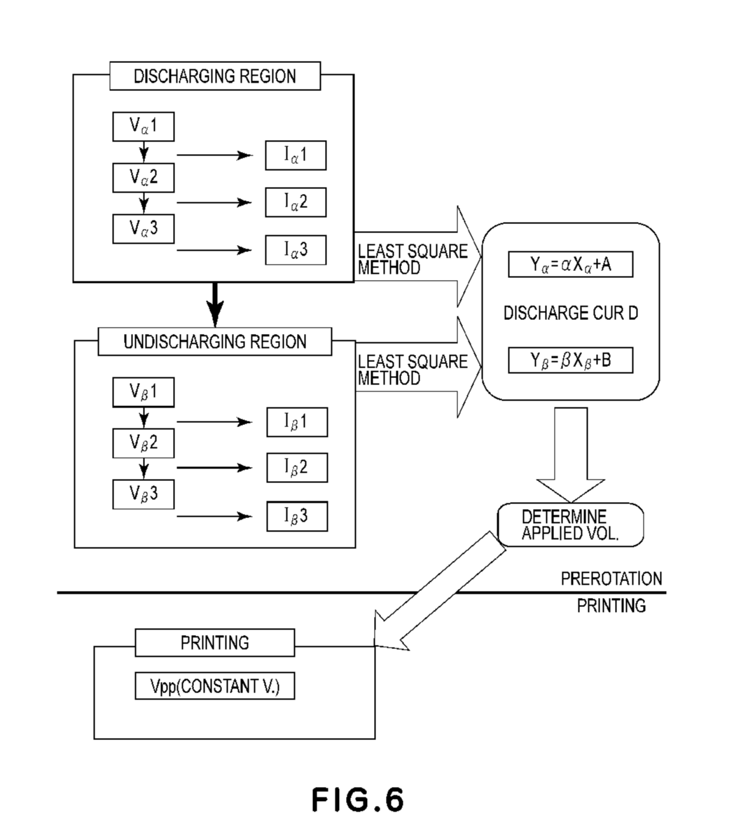

Then, as shown in FIG. 6, the control circuit 34 effects a linear approximation of the relation between the charging AC voltage and the charging AC current using a least square approximation from the measured currents in the discharging region and un-discharging range, thus providing the following formulas:

Approximated line for the discharge range: Yα=αXα+A (2).

Approximated line for the un-discharging range: Yβ=βXβ+B (3).

Thereafter, the control circuit 34 determines the charging AC voltage Vpp with which the difference between the formula (2) and the formula (3) is the discharge current D, by the following:

Vpp=(D−A+B)/(α−β) (4)

Here, this results as follows: Since the difference between the formula (2) and the formula (3) is D,

Yα−Yβ=(αXα+A)−(βXβ+B)=D

Then X=Vpp providing D satisfies,

(αVpp+A)−(βVpp+B)=D.

Therefore,

Vpp=(D−A+B)/(α−β).

In the printing step, the charging AC voltage applied to the charging roller 2 is switched to the value determined by equation (4), with which the constant-voltage-control is carried out.

In this manner, in this embodiment, for every printing preparation rotating operation, the charging AC voltage required to provide the discharge current necessary in the printing step is calculated. During the printing step, the determined charging AC voltage is supplied with a constant voltage control. By this, variations in the electric resistances or the variations in the properties of the voltage source circuits of the image forming apparatus 100 which are attributable to the manufacturing errors and/or material property variations due to the ambient condition variation of the charging roller 2 and the photosensitive drum 1 can be accommodated, and therefore, further correct discharge current can be provided.

### 7. Control of the Charging AC Voltage in Color Image Formation Portion:

The control of the charging AC voltage supplied from the common AC voltage source and applied to the charging rollers 2a, 2b, 2c of the color image formation portions Sa, Sb, Sc will be described. Here, the charging AC voltage applied to the charging roller 2d of the black image forming station Sd can be obtained directly through the above-described method.

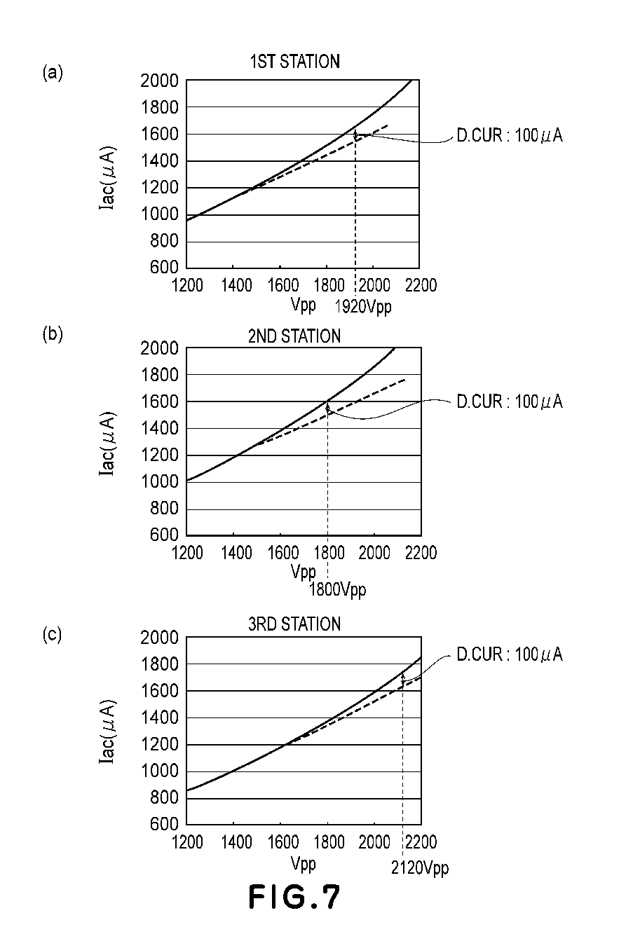

Parts (a), (b) and (c) of FIG. 7 shows an example of the relationship (Vpp−Iac) between the charging AC voltage Vpp and the charging AC current Iac obtained for the first, second and third image forming stations Sa, Sb, Sc, respectively.

As shown in FIG. 7, the plots of Vpp−Iac of the first, second and third image forming stations Sa, Sb, Sc may be deviated due to the difference in the use frequency, the replacement timing of the photosensitive drum 1, the electric resistance of the charging roller 2 or the like. As a result, in the example of FIG. 7, the required charging AC voltages calculated through the above-described method of this embodiment when the required discharge current is 100 μA are as follows: In the first image forming station Sa, it is 1920 Vpp; in the second image forming station Sb, it is 1800 Vpp, and in the third image forming station Sc it is 2120 Vpp.

In the case that the voltage source for applying the charging AC voltage to the charging member of each image forming station is provided, the required charging AC voltage is determined for each image forming station, and the obtained charging AC voltage is applied to the charging member of the associated image forming station, by which the proper discharge current can be provided. However, when a common voltage source is used to apply the charging AC voltages to the charging members of the image forming stations, it is not possible to apply different charging AC voltages to the image forming stations.

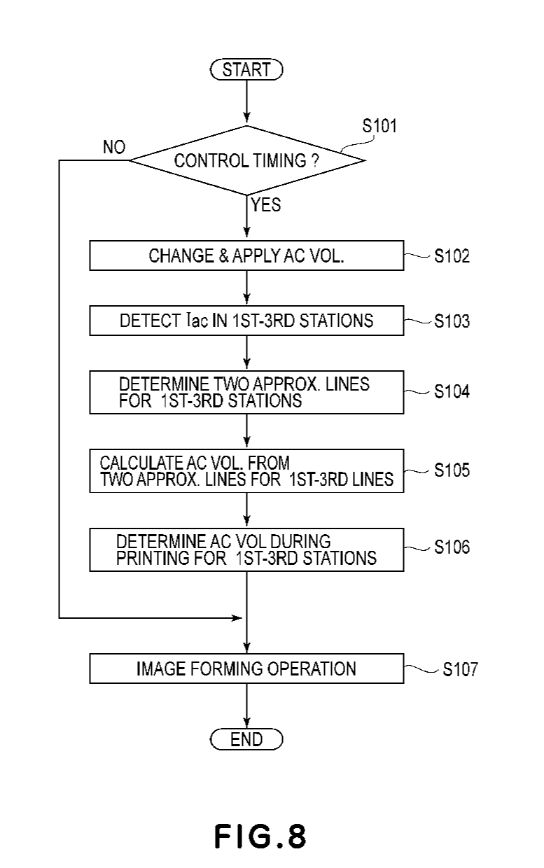

FIG. 8 shows a process of controlling the charging AC voltage applied to the charging rollers 2a, 2b, 2c of the color image formation portions Sa, Sb, Sc from the common AC voltage source.

The CPU 70 starts the process at the timing of the charging bias voltage control (at the printing preparation rotating operation in this embodiment) (S101). First, the charging AC voltages applied to the charging rollers 2a, 2b, 2c are sequentially switched to three points in the discharge range and three points in the un-discharging range by the first AC amplifying circuit 25a (S102). When the charging AC voltages are outputted, the charging AC voltages are measured by the AC current measuring devices 30a, 30b, 30c for the first, second and third image forming stations Sa, Sb, Sc, respectively, and the measurements are stored in the memory 60 (S103).

Then, the CPU 70 calculates two approximated lines through the calculating method described in conjunction with FIGS. 5 and 6, from the information of the charging AC currents stored in the memory 60 (S104). The information includes the information for the three points (Vα1, Iα1), (Vα2, Iα2), (Vα3, Iα3) in the discharge range, and the information for the three points (Vβ1, Iβ1), (Vβ2, Iβ2), (Vβ3, Iβ3) in the un-discharging range.

Then, the CPU 70 calculates the required charging AC voltage for the required discharge current for each of the first, second and third image forming stations Sa, Sb, Sc using formula 4 (S105). In this embodiment, the required discharge current is 100 μA. The required charging AC voltages for the discharge current of 100 μA obtained by the calculation are, as shown in FIG. 7, for example, 1920 Vpp in the first image forming station Sa, 1800 Vpp in the second image forming station Sb and 2120 Vpp in the third image forming station Sc. In this case, in this embodiment, the CPU 70 selects 2120 Vpp which is for the third image forming station Sc and which is the maximum charging AC voltage, as the charging AC voltages applied to the color image formation portions Sa, Sb, Sc during the printing step (S106). The charging AC voltage of the charging voltage is constant-voltage-controlled during the image forming operation (S107).

If, in S101, the result of the discrimination indicates that it is not the timing of the charging bias voltage control, the processes S102-S105 are not carried out, and the image forming operation is executed with the previous setting of the charging AC voltage (S107).

As will be understood from the foregoing, in this embodiment, the image forming apparatus 100 includes an AC voltage source 21 for outputting the AC voltage to be applied commonly to at least two charging members. The image forming apparatus 100 includes the AC current measuring device 30 for measuring the AC current flowing into the at least two charging member when the AC voltage is applied from the AC voltage source 21. The image forming apparatus 100 includes the control means 70 (CPU) for controlling the peak-to-peak voltages of the AC voltage applied to at least two charging member from the AC voltage source 21. The control means 70 carries out the following controls. The AC voltages are applied to at least two charging members from the AC voltage source, and the AC current flowing into the respective charging members are measured by the AC current measuring devices, and then the peak-to-peak voltages of the AC voltages required to be applied from the AC voltage sources to provide the predetermined discharge currents are calculated from the result of measurements. The maximum value of the peak-to-peak voltages of the required AC voltages obtained by the calculation is determined as the target value of the constant-voltage-control during the image formation. Particularly, in this embodiment, the control means 70 carried out the following calculations, when the predetermined discharge current is D, and the discharge starting voltage to the photosensitive member when a DC voltage is applied to the charging member is Vth. A function Yα between the peak-to-peak voltage and the AC current measured by the AC current measuring device 30 when AC voltages having peak-to-peak voltages of not less than Vth×2 at at least two points are applied from the AC voltage source 21 is obtained. A function Yβ between the peak-to-peak voltage and the AC current measured by the AC current measuring device 30 when a AC voltage having peak-to-peak voltage of less than Vth×2 at at least one point is applied from the AC voltage source 21 is obtained. By comparing functions Yα and Yβ, a peak-to-peak voltage providing Yα−Yβ=D is determined as the required peak-to-peak voltage.

In this embodiment, the discharge currents are that provided by the maximum calculated charging AC voltage among the image forming stations which are supplied from the common AC voltage source. By dosing so, in the other image forming stations connected commonly to the AC voltage source, no image defects attributable to the improper charging of the photosensitive drum 1 such as foggy background or sandpaper-like background appear. As for at least one image forming station among the image forming stations having the common AC voltage source, a necessary charging AC voltage for the necessary discharge voltage is applied. Also, as for the other image forming stations among the image forming stations having the common AC voltage source, the discharge current part which is the different of the calculated charging AC voltage from the maximum value is predicted as working disadvantageously with respect to the wearing of the photosensitive drum 1. Therefore, the remaining lifetime of the photosensitive drum 1 can be predicted. The excessive discharge amount is normally smaller than the excessive discharge amount in the known AC constant-current-control type system.

In this embodiment, the approximated lines are determined from the data of the charging AC voltages and the charging AC currents in the discharge range and the un-discharging range, respectively. However, as will be readily understood by one skilled in the art, the approximated line can be determined from at least two points in the discharge range. In the un-discharging range, the approximated line can be determined from the zero point and at least one point (Yβ=βXβ in such a case).

As described in the foregoing, according to this embodiment, with the inexpensive and small size structure employing one AC voltage source for outputting a charging AC voltage for each of the image forming stations, the suppression of the image defect attributable to the improper charging of the photosensitive member such as the sandpaper like background and/or the fog and the suppression of wearing promotion of the photosensitive member attributable to the excessive discharge can be accomplished. Therefore, the low cost, the downsizing of the device can be accomplished, while maintaining high image quality for long term. That is, according to this embodiment, in an image forming apparatus comprising a plurality of image forming stations, even when the voltage source for applying the voltages to the charging members is common to the image forming station, the required sufficient discharge currents can be provided for all of the image forming stations.

### Embodiment 2

Another embodiment will be described. The fundamental structures and operations of the image forming apparatus of this embodiment are the same as those of the embodiment 1. In the description of this embodiment, the same reference numerals as in Embodiment 1 are assigned to the elements having the corresponding functions in this embodiment, and the detailed description thereof is omitted for simplicity.

In Embodiment 1, the necessary charging AC voltage for the necessary discharge current is calculated, and the constant-voltage-control is carried out with the charging AC voltage. On the contrary, in this embodiment, a necessary charging AC current for the necessary discharge current is calculated, and a constant-current-control is carried out with the charging AC current.

The description will first be made as to a control of the discharge current in this embodiment with respect to one image forming station (that is, one charging roller). A determination method of a charging AC voltage when a common AC voltage source is used for a plurality of image forming stations will be described in detail hereinafter.

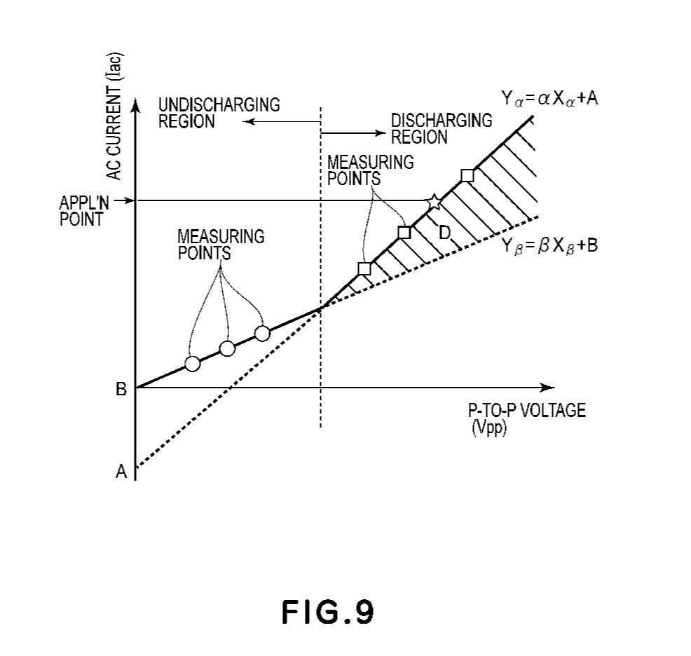

As shown in FIG. 9, a control circuit 34 controls an AC voltage source portion 21 to sequentially change the charging AC voltage so that the charging AC current takes three point in a discharge region and three points in an un-discharging range, while applying the voltage to the charging roller 2. When the charging AC current is provided, the charging AC voltage outputted by the AC voltage source portion 21 at that time is measured.

More particularly, in this embodiment, the control circuit 34 changes the charging AC voltage by AC amplifying circuits 25a, 25b to adjust to a predetermined charging AC current while measuring an AC current Iac flowing into the charging roller 2 through a photosensitive drum 1 by an AC current measurement circuit 30. When the predetermined charging AC current is measured, the information of the charging AC voltage outputted from the AC voltage source portion 21 is inputted to the control circuit 34 from the AC amplifying circuits 25a, 25b in the AC voltage source portion 21.

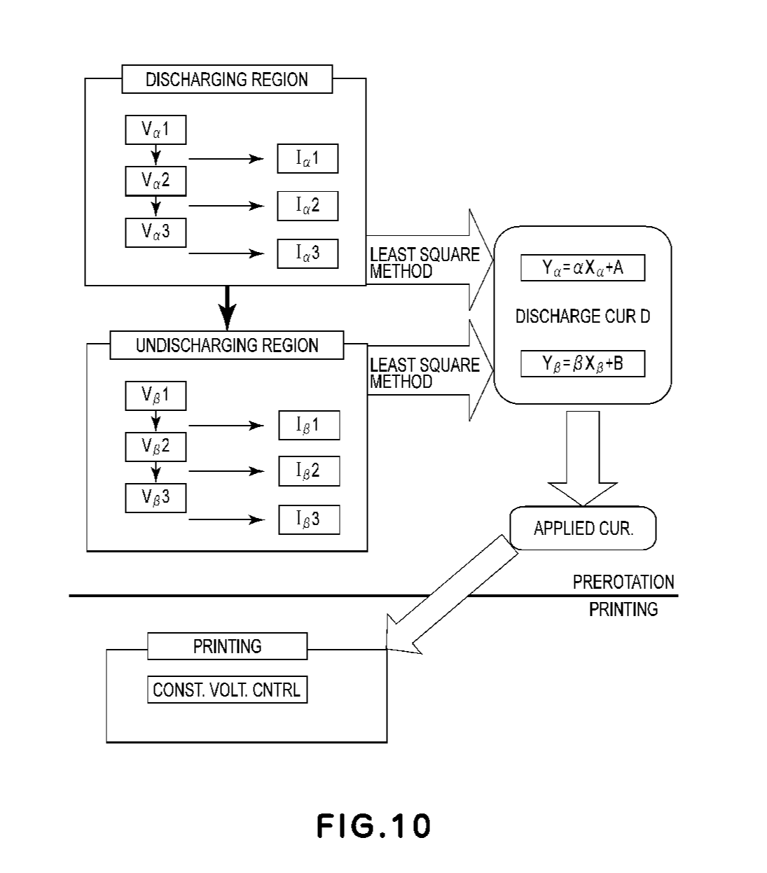

Then, as shown in FIG. 10, the control circuit 34 effects a linear approximation of the relation between the charging AC voltage and the charging AC current using a least square approximation from the measured currents in the discharging region and un-discharging range, thus providing the following formulas:

Approximated line for the discharge range: Yα=αXα+A (2)

Approximated line for the un-discharging range: Yβ=βXβ+B (3)

Thereafter, the control circuit 34 determines the charging AC current Iac with which the difference between the formula (2) and the formula (3) is the discharge current D, by the following:

When the charging AC current with which the difference is discharge current D is Iac1, and a charging AC voltage at this time is Vpp, then the equations (2) and (3) are,

Iac1=αVpp+A (5)

Iac2=βVpp+B (6).

Here, Iac2 is an AC current providing Vpp in the approximated line Yβ in the un-discharging range. In addition, the following equation is true:

Iac1=Iac2+D (7).

From equations (5), (6) and (7), the charging AC current Iac with which the difference is the discharge current D is determined by the following equation (8):

Iac=(αD+αB−βA)/(α−β) (8).

In the printing step, the constant-current-control is carried out such that the charging AC current flowing into the charging roller 2 is the value obtained by the equation (8).

In this manner, in this embodiment, for every printing preparation rotating operation, the charging AC current required to provide the discharge current necessary in the printing step is calculated. During the printing step, the determined charging AC current is supplied with a constant current control. By this, variations in the electric resistances or the variations in the properties of the voltage source circuits of the image forming apparatus 100 which are attributable to the manufacturing errors and/or material property variations due to the ambient condition variation of the charging roller 2 and the photosensitive drum 1 can be accommodated, and therefore, further correct discharge current can be provided.

The control of the charging AC voltage supplied from the common voltage source and applied to the charging rollers 2a, 2b, 2c of the color image formation portions Sa, Sb, Sc will be described. Here, the control of the charging AC voltage applied to the charging roller 2d of the black image forming station Sd can be determined directly through the above-described method.

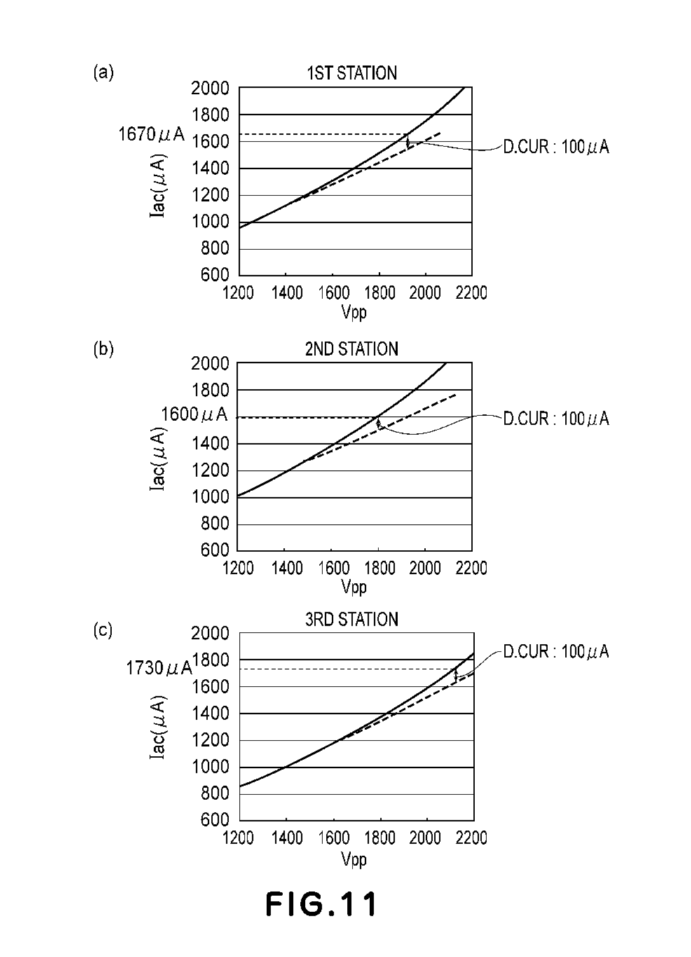

Parts (a), (b) and (c) of FIG. 11 shows an example of the relationship (Vpp−Iac) between the charging AC voltage Vpp and the charging AC current Iac obtained for the first, second and third image forming stations Sa, Sb, Sc, respectively.

As shown in FIG. 11, the plots of Vpp−Iac of the first, second and third image forming stations Sa, Sb, Sc may be deviated due to the difference in the use frequency, the replacement timing of the photosensitive drum 1, the electric resistance of the charging roller 2 or the like. As a result, in the example of FIG. 11, the required charging AC voltages calculated through the above-described method of this embodiment when the required discharge current is 100 μA are as follows: In the first image forming station Sa, it is 1670 μA; in the second image forming station Sb, it is 1600 μA, and in the third image forming station Sc it is 1730 μA.

In the case that the voltage source for applying the charging AC voltage to the charging member of each image forming station is provided, the required charging AC voltage is determined for each image forming station, and the obtained charging AC voltage is applied to the charging member of the associated image forming station, by which the proper discharge current can be provided. However, a common voltage source is used to apply the charging AC voltages to the charging members of the image forming stations, it is not possible to apply different charging AC voltages to the image forming stations.

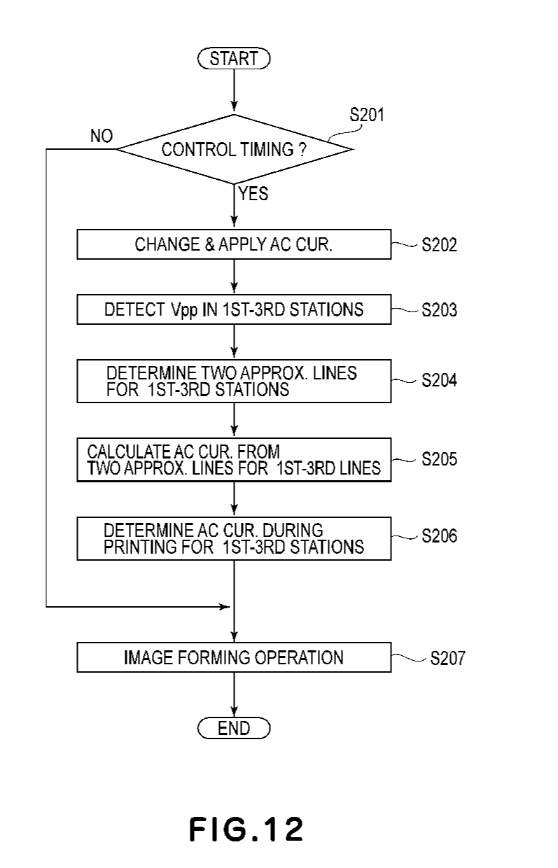

FIG. 12 shows a process of controlling the charging AC voltage applied to the charging rollers 2a, 2b, 2c of the color image formation portions Sa, Sb, Sc from the common AC voltage source.

The CPU 70 starts the process at the timing of the charging bias voltage control (at the printing preparation rotating operation in this embodiment) (S201). First, the charging AC voltages applied to the charging rollers 2a, 2b, 2c are sequentially switched so that the charging AC current values take three points in the discharge range and three points in the un-discharging range by the first AC amplifying circuit 25a (S202). When the charging AC voltages are outputted, the charging AC voltages are measured for the first, second and third image forming stations Sa, Sb, Sc, when the predetermined charging AC currents are measured, respectively, and the measurements are stored in the memory 60 (S503). At this time, the charging AC voltage is known from a control signal value of the first AC amplifying circuit 25a.

Then, the CPU 70 calculates two approximated lines through the calculating method described in conjunction with FIGS. 9, 10, from the stored information of the charging AC currents stored in the memory 60 (S204). The information includes the information for the three points (Vα1, Iα1), (Vα2, Iα2), (Vα3, Iα3) in the discharge range, and the information for the three points (Vβ1, Iβ1), (Vβ2, Iβ2), (Vβ3, Iβ3) in the un-discharging range.

Then, the CPU 70 calculates the required charging AC voltage for the required discharge current for each of the first, second and third image forming stations Sa, Sb, Sc using formula 8 (S205). In this embodiment, the necessary discharge current is 100 μA. The required charging AC currents for the discharge current of 100 μA obtained by the calculation are, as shown in FIG. 11, for example, 1670 μA in the first image forming station Sa, 1600 μA in the second image forming station Sb and 1730 μA in the third image forming station Sc. In this case, in this embodiment, the CPU 70 selects 1730 μA which is for the third image forming station Sc and which is the maximum charging AC current, as the charging AC current applied to the color image formation portions Sa, Sb, Sc during the printing step (S206). The image forming operation is carried out, while effecting a constant-current-control by controlling the charging AC voltage so that the determined charging AC current is provided (S207). During the printing step, the measured value of the AC current measuring device of the image forming station with which the charging AC current is the maximum is fed back, and the output of the AC voltage source portion 21 is controlled to effect the constant-current-control on the basis of the fed back data.

If, in S201, the result of the discrimination indicates that it is not the timing of the charging bias voltage control, the processes S202-S206 are not carried out, and the image forming operation is executed with the previous setting of the charging AC voltage (S207).

As will be understood from the foregoing, in this embodiment, the image forming apparatus 100 includes an AC voltage source 21 for outputting the AC voltage to be applied commonly to at least two charging members. The image forming apparatus 100 includes the AC current measuring device 30 for measuring the AC current flowing into the at least two charging member when the AC voltage is applied from the AC voltage source 21. The image forming apparatus 100 includes the control means (CPU) 70 for controlling the peak-to-peak voltages of the AC voltage applied to at least two charging member from the AC voltage source 21. The control means 70 carries out the following controls. The AC voltages are applied to at least two charging members from the AC voltage source, and the AC current flowing into the respective charging members are measured by the AC current measuring devices, and then the AC current required to be applied to the charging member to provide the predetermined discharge currents are calculated from the result of measurements. The maximum value of the required AC currents obtained by the calculation is determined as the target value of the constant-current-control during the image formation. Particularly, in this embodiment, the control means 70 carried out the following calculations, when the predetermined discharge current is D, and the discharge starting voltage to the photosensitive member when a DC voltage is applied to the charging member is Vth. A function Yα between the peak-to-peak voltage of the AC voltage outputted by the AC voltage source 21 and the AC current when AC voltages having peak-to-peak voltages of not less than Vth×2 at at least two points are applied from the AC voltage source 21 is obtained. A function Yα between the peak-to-peak voltage of the AC voltage outputted by the AC voltage source 21 and the AC current when AC voltage having peak-to-peak voltage of less than Vth×2 at at least one point is applied from the AC voltage source 21 is obtained. By comparing functions Yα and Yβ, a peak-to-peak voltage providing Yα−Yβ=D is determined as the required peak-to-peak voltage.

In this embodiment, the charging AC currents are that provided by the maximum calculated charging AC current among the image forming stations which are supplied from the common AC voltage source. By dosing so, in the other image forming stations connected commonly to the AC voltage source, no image defects attributable to the improper charging of the photosensitive drum 1 such as foggy background or sandpaper-like background appear. As for at least one image forming station among the image forming stations having the common AC voltage source, a necessary charging AC voltage for the necessary discharge current is provided. Also, as for the other image forming stations among the image forming stations having the common AC voltage source, the discharge current part which is the different of the calculated charging AC current from the maximum value is predicted as working disadvantageously with respect to the wearing of the photosensitive drum 1. Therefore, the remaining lifetime of the photosensitive drum 1 can be predicted. The excessive discharge amount is normally smaller than the excessive discharge amount in the known AC constant-current-control type system.

In this embodiment, the approximated lines are determined from the data of the charging AC voltages and the charging AC currents in the discharge range and the un-discharging range, respectively. However, as will be readily understood by one skilled in the art, the approximated line can be determined from at least two points in the discharge range. In the un-discharging range, the approximated line can be determined from the zero point and at least one point (Yβ=βXβ in such a case).

As described in the foregoing, the similar effects to Embodiment 1 can be provided also according to this embodiment.

### Embodiment 3

Another embodiment will be described. The fundamental structures and operations of the image forming apparatus of this embodiment are the same as those of the embodiment 1. In the description of this embodiment, the same reference numerals as in Embodiment 1 are assigned to the elements having the corresponding functions in this embodiment, and the detailed description thereof is omitted for simplicity.

In Embodiment 1, the relative humidity measured by the ambient condition sensor 35 is 50%, as an example. In this embodiment, a suppressing operation against the image flow is executed when in one or more image forming stations, the relative humidity is not less than a predetermined value, and a discharge current is not less than a predetermined value.

When, as in Embodiment 1, the maximum charging AC voltage is applied to all of the image forming stations from a common AC voltage source, the excessive discharge may occur in one or more image forming stations.

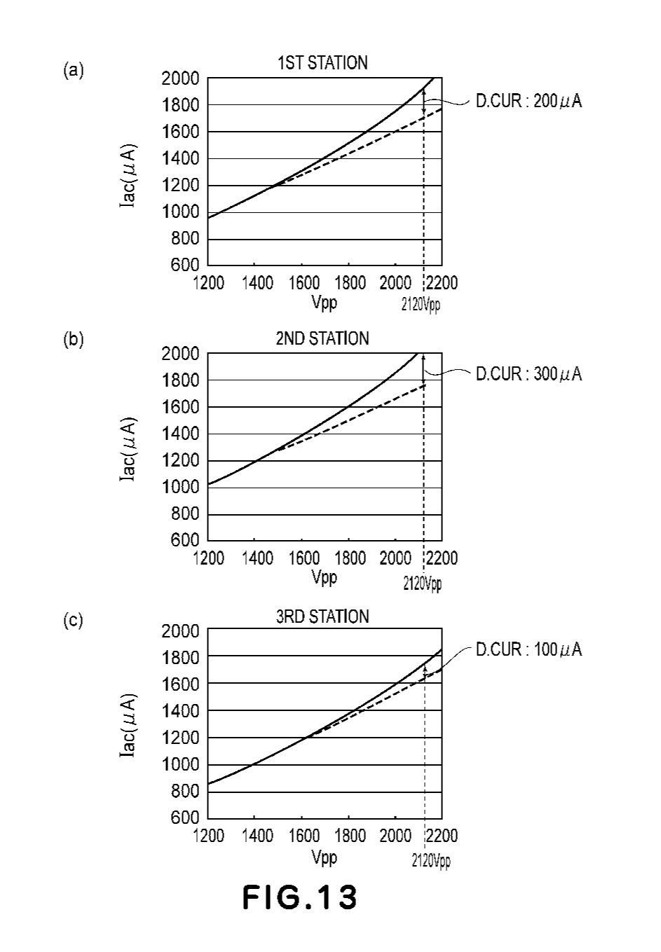

Parts (a), (b) and (c) of FIG. 13 show relations between the charging AC current and the charging AC voltage in the first, second, and third image forming stations Sa, Sb, Sc under an extreme condition in which the discharge tends to be excessive in one or more image forming stations. The use amount of the photosensitive drum 1a 40000 sheets (A4 size); that of the second image forming station Sb is 80000 sheets (scraping amount is maximum, and the replacement timing is reached); that of the third image forming station Sc is zero (fresh drum).

As shown in FIG. 13, it is assumed that the charging AC voltages for all of the first-third image forming stations Sa-Sc are based on 2120 Vpp which is the voltage in the third image forming station Sc where the charging AC voltage necessary for discharge current 100 μA is the maximum value when the calculation is made in accordance with embodiment 1. In this case, the discharge current is 200 μA in the first image forming station Sa, and the discharge current is 300 μA in the second image forming station Sb.

If the photosensitive drums 1 of the image forming stations Sa, Sb, Sc are simultaneously replaced, the discharge currents are not so different. However, when the photosensitive drums 1 of the image forming stations Sa, Sb, Sc are individually replaceable, the discharge currents may be so large.

As shown in FIG. 13, in the state that the discharge currents are different, the image flow occurs only in the second image forming station Sb when the relative humidity measured by the ambient condition sensor 35 is 80%, for example. In the second image forming station Sb, the discharge current is larger than in the first and third image forming stations Sa, Sc, and the amount of the electric discharge product such as ozone and/or NOx is large, they may be deposited on the surface of the photosensitive drum 1. Under the high humidity ambience, the deposited matter on the surface of the photosensitive drum 1 absorbs moisture, and the charge retention performance of the surface of the photosensitive drum 1 decreases, resulting in the image flow.

With the structure of this embodiment, it has been found that the image flow occurs when the relative humidity measured by the ambient condition sensor 35 is not less than 70%, and the discharge current is not less than 250 μA. So, in this embodiment, if there is an image forming station in which the relative humidity measured by the ambient condition sensor 35 is not less than 70%, and the discharge current is not less than 250 μA, an image flow suppressing operation is executed in such an image forming station. In the image flow suppressing operation, the photosensitive drum 1 is rotated, and the surface thereof is rubbed. Particularly, in this embodiment, the photosensitive drum 1 is rotated, by which the surface is scraped by the cleaning blade of the drum cleaning device 6. In this embodiment, in the image flow suppressing operation, the toner powder (including an externally added material) as an abrading material is transferred onto the photosensitive drum 1 from the developing device 4, thus supplying it to a contact portion between the cleaning blade and the photosensitive drum 1 to promote removal of the electric discharge product.

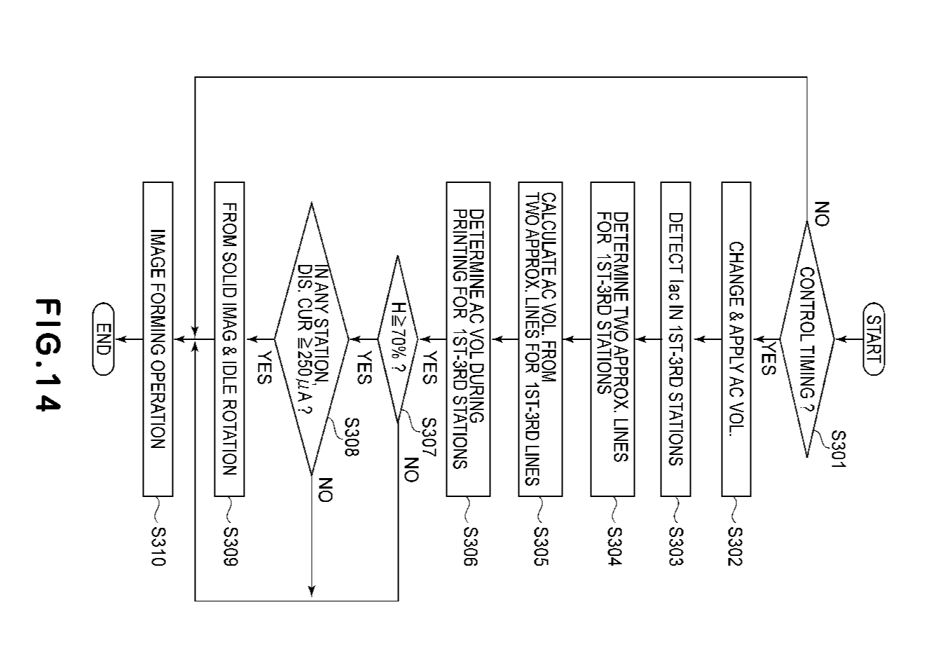

FIG. 14 shows a process of the control for the image flow suppressing operation and a control of the charging AC voltage for applying to the color image formation portions Sa, Sb, Sc in this embodiment.

The CPU 70 starts the process at the timing of the charging bias voltage control (at the printing preparation rotating operation in this embodiment) (S301). First, the charging AC voltages applied to the charging rollers 2a, 2b, 2c are sequentially switched to three points in the discharge range and three points in the un-discharging range by the first AC amplifying circuit 25a (S302). When the charging AC voltages are outputted, the charging AC voltages are measured by the AC current measuring devices 30a, 30b, 30c for the first, second and third image forming stations Sa, Sb, Sc, respectively, and the measurements are stored in the memory 60 (S103).

Then, the CPU 70 calculates two approximated lines through the calculating method described in Embodiment 1, from the information of the charging AC currents stored in the memory 60 (S304). The information includes the information for the three points (Vα1, Iα1), (Vα2, Iα2), (Vα3, Iα3) in the discharge range, and the information for the three points (Vβ1, Iβ1), (Vβ2, Iβ2), (Vβ3, Iβ3) in the un-discharging range.

Then, the CPU 70 calculates the required charging AC voltage for the required discharge current for each of the first, second and third image forming stations Sa, Sb, Sc using formula 4 of Embodiment 1 (S305). In this embodiment, the required discharge current is 100 μA. The required charging AC voltages for the discharge current of 100 μA obtained by the calculation are, as shown in FIG. 7, for example, 1920 Vpp in the first image forming station Sa, 1800 Vpp in the second image forming station Sb and 2120 Vpp in the third image forming station Sc. In this case, in this embodiment, the CPU 70 selects 2120 Vpp which is for the third image forming station Sc and which is the maximum charging AC voltage, as the charging AC voltages applied to the color image formation portions Sa, Sb, Sc during the printing step (S306).

Then, the CPU 70 discriminates whether or not the relative humidity measured by the ambient condition sensor 35 is not less than 70% (S307). When the relative humidity is not less than 70% in step S307, the CPU 70 discriminates whether or not the discharge currents in the first and second image forming stations Sa, Sb are not less than 250 μA if the maximum charging AC voltage which is determined in the step S306 (S308). The CPU 70 can determine the discharge currents for the first and second image forming stations Sa, Sb from the two approximated lines calculated for the first and second image forming stations Sa, Sb.

If the result of the discrimination is affirmative, that is, there is an image forming station with which the discharge current is not less than 250 μA, the image flow suppressing operation is executed for the image forming state (S309). In this embodiment, in the image flow suppressing operation, a solid image (maximum density level) covering the entire longitudinal range of the photosensitive drum 1 and three circumferential length of the photosensitive drum 1 is developed. The toner is supplied to the contact portion (cleaning portion) between the photosensitive drum 1 and the cleaning blade of the drum cleaning device 6 over the entire longitudinal range. Then, the photosensitive drum is idly rotated for one minute. By doing so, the toner and/or the externally added material included in the toner rubs the photosensitive drum 1 to remove the electric discharge product from the surface of the photosensitive drum 1. With the structure of this embodiment, the image flow is suppressed by the idle rotating operation for one minute.

After the completion of the idle rotating operation of the photosensitive drum 1 for the image flow suppressing operation, the image forming operation is carried out while effecting the constant-voltage-control for the charging AC voltage of the charging voltage so as to provide the charging AC voltage determined in the S306 (S310).

If the relative humidity is discriminated as being less than 70% in the step S307 or if there is no image forming station with which the discharge current is not less than 250 μA in the step S308, the operation does not go to the image flow suppressing operation (S309), but directly goes to the image forming operation (S310).

If, in S101, the result of the discrimination indicates that it is not the timing of the charging bias voltage control, the processes S302-S305 are not carried out, and the image forming operation is executed with the previous setting of the charging AC voltage (S306).

As described in the foregoing, in this embodiment, the image forming apparatus 100 includes the rubbing operation executing means for executing the rubbing operation on the surface of the photosensitive member in the following case. The rubbing operation executing means discriminates whether or not there is a charging member which is other than the charging member for which the charging AC current is the maximum value among the at least two charging members to which the AC voltage source 21 is common and which the discharge current is not less than the predetermined value when the AC voltage is controlled using the target value. In addition, if there is such a charging member, the rubbing operation executing means discriminates whether or not the humidity is not less than the predetermined value. When there is such a charging member and the humidity is not less than the predetermined value, the rubbing operation executing means executes the operation for rubbing the surface of the photosensitive member to be charged by the charging member. In this embodiment, in the operation, the abrading material is supplied to the photosensitive member. In this embodiment, the CPU 70 has a function of the rubbing operation executing means.

The apparatus of this embodiment has the same structure as the structure of Embodiment 1 in which the constant-voltage-control of the charging AC voltage is effected, but further comprises the image flow suppressing operation means. The image flow suppressing operation means may be incorporated in the apparatus of embodiment 2. In this case, the image flow suppressing operation is executed for an image forming station which is other than the image forming station where the maximum value of the charging AC current is calculated and in which the discharge current is not less than the predetermined value if the constant-current-control is effected with the maximum value charging AC current.

As described in the foregoing, according to this embodiment, the occurrence of the image flow attributable to a large difference of the discharge current when the same charging AC voltage is applied and there is a difference in the scraping amount of the photosensitive drum 1, for example.

### Embodiment 4

A further embodiment will be described. The fundamental structures and operations of the image forming apparatus of this embodiment are the same as those of the embodiment 1. In the description of this embodiment, the same reference numerals as in Embodiment 1 are assigned to the elements having the corresponding functions in this embodiment, and the detailed description thereof is omitted for simplicity.

In Embodiment 3, in order to suppress the image flow caused by the excessive discharge, the image flow suppressing operation including the idle rotating operation of the photosensitive drum 1 has been employed. However, the idle rotating operation of the photosensitive drum 1 results in reduction of the throughput of the image forming apparatus.

On the other hand, as to the image forming station (the second image forming station Sb in the example of Embodiment 3) in which the photosensitive drum 1 has been scraped to the maximum and is near to the lifetime end, the photosensitive drum 1 is desirably replaced immediately. If further image forming operations are carried out in such an image forming station, the photosensitive drum 1 is scraped further with the result of larger difference in the discharge currents among the image forming stations.

Under the circumstances, in this embodiment, if there is an image forming station in which the discharge current is larger than the required discharge current by more than a predetermined amount, information promoting the replacement of the photosensitive drum 1 of such an image forming station is displayed. In this embodiment, if there is an image forming station with which the discharge current is equal to or more than three times the required discharge current, a message (replacement message) promoting replacement of the photosensitive drum 1 of such an image forming station is displayed on a display screen of the operating portion provided on the image forming apparatus 100.

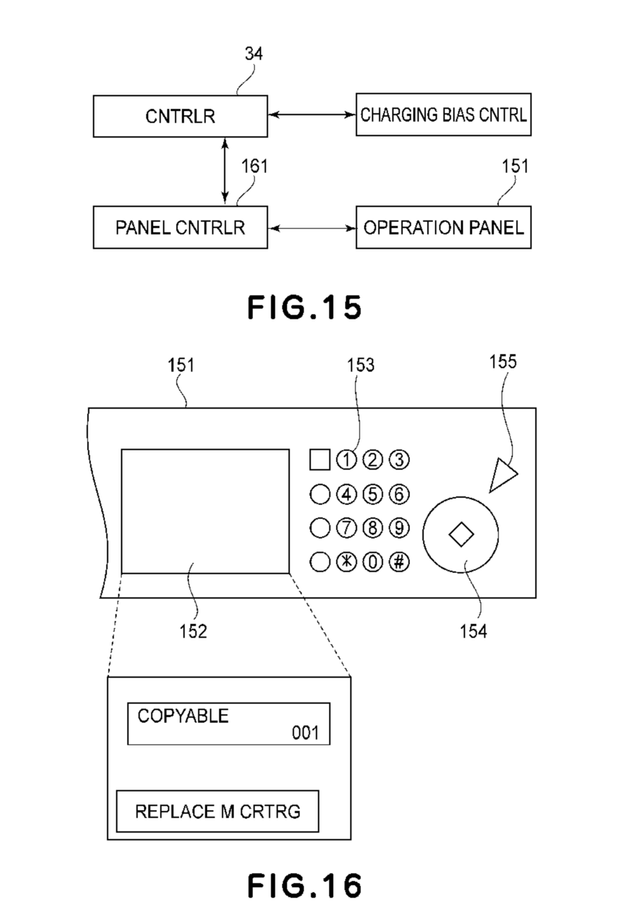

FIG. 15 is a block diagram of a process of displaying the exchange message of this embodiment. In this embodiment, if there is an image forming station in which the discharge current is not less than three times the required discharge current, a control circuit 34 sends the information (replacement information) indicative of the replacement of the photosensitive drum 1 of the image forming station to an operating portion control circuit 161 as operating portion control means.

FIG. 16 is a schematic view of an operating portion 151 of the image forming apparatus 100 of this embodiment. The operating portion 151 includes a display screen (liquid crystal touch panel) 152, a ten-key 153 for inputting a number of image formations (print count), a start key 154 and a stop key 155. When the replacement information for the second image forming station (magenta (M) image forming station) Sb, for example, is transmitted to the operating portion control circuit 161, the replacement timing of the photosensitive drum 1b of the second image forming station Sb is displayed on the display screen 152 of the operating portion 151. In this particular embodiment, the message prompts the replacement of the cartridge including the photosensitive drum 1, the charging roller 2 and the drum cleaning device 6.

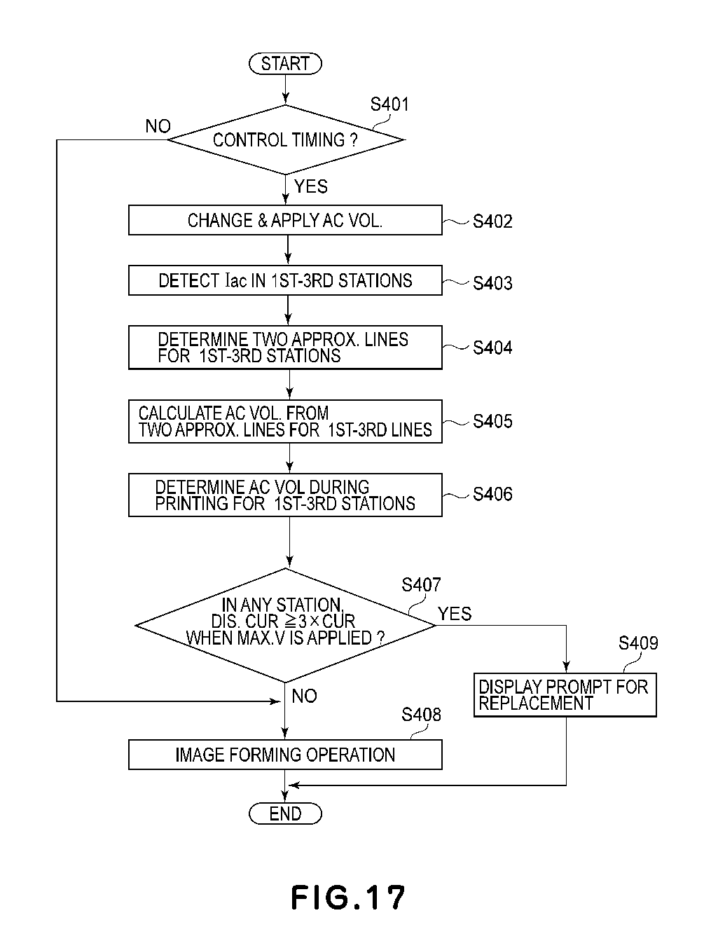

FIG. 17 shows a process of the control for displaying the replacement message and the control of the charging AC voltages applied to the color image formation portions Sa, Sb, Sc in this embodiment.

The CPU 70 starts the process at the timing of the charging bias voltage control (at the printing preparation rotating operation in this embodiment) (S101). First, the charging AC voltages applied to the charging rollers 2a, 2b, 2c are sequentially switched to three points in the discharge range and three points in the un-discharging range by the first AC amplifying circuit 25a (S402). When the charging AC voltages are outputted, the charging AC voltages are measured by the AC current measuring devices 30a, 30b, 30c for the first, second and third image forming stations Sa, Sb, Sc, respectively, and the measurements are stored in the memory 60 (S403).

Then, the CPU 70 calculates two approximated lines through the calculating method described in Embodiment 1, from the information of the charging AC currents stored in the memory 60 (S404). The information includes the information for the three points (Vα1, Iα1), (Vα2, Iα2), (Vα3, Iα3) in the discharge range, and the information for the three points (Vβ1, Iβ1), (Vβ2, Iβ2), (Vβ3, Iβ3) in the un-discharging range.

Then, the CPU 70 calculates the required charging AC voltage for the required discharge current for each of the first, second and third image forming stations Sa, Sb, Sc using formula 4 of Embodiment 1 (S405). Then, the CPU 70 determines the maximum value of the charging AC voltages calculated for the first, second and third image forming stations Sa, Sb, Sc, as the charging AC voltage applied to the color image formation portions Sa, Sb, Sc during the printing step (S406).

Subsequently, the CPU 70 discriminates whether or not there is an image forming station in which the discharge current required when the maximum charging AC voltage determined in the step S406 is not less than three times the required discharge current. If the result of the discrimination in the step S407 is negative (there is no such image forming station), the image forming operation is carried out with the constant-voltage-control of the charging AC voltage of the charging voltage at the charging AC voltage determined in the step S406 (S408). Here, the CPU 70 can determine the discharge currents of the image forming stations from the two approximated line calculated for the image forming stations. On the other hand, if the discrimination in the step S407 is affirmative, the CPU 70 displays the replacement message for the photosensitive drum 1 of such an image forming station on the operating portion 151 (S409). In this embodiment, the replacement message prompts the replacement of the cartridge including the photosensitive drum 1, the charging roller and the drum cleaning device.

If, in S401, the result of the discrimination indicates that it is not the timing of the charging bias voltage control, the processes S402-S407 are not carried out, and the image forming operation is executed with the previous setting of the charging AC voltage (S408).

As will be understood from the foregoing, in this embodiment, the image forming apparatus 100 includes notifying operation executing means for executing the operation of promoting the replacement of the photosensitive member in the following cases. The notifying operation executing means discriminates whether or not there is a charging member which is other than the charging member for which the charging AC current is the maximum value among the at least two charging members to which the AC voltage source 21 is common and which the discharge current is not less than the predetermined value when the AC voltage is controlled using the target value. If there is such a charging member, the notifying operation executing means prompts replacement of the photosensitive member to be charged by the charging member. In this embodiment, the CPU 70 has the function of the notifying operation executing means.

The apparatus of this embodiment has the same structure as the structure of Embodiment 1 in which the constant-voltage-control of the charging AC voltage is effected, but further comprises the means for displaying operation execution control. The means for the execution control of the replacement message displaying operation may be incorporated in the apparatus of Embodiment 2. In this case, the photosensitive drum replacement promoting operation is executed for an image forming station which is other than the image forming station where the maximum value of the charging AC current is calculated and in which the discharge current is not less than the predetermined value if the constant-current-control is effected with the maximum value charging AC current. Also, the control of this embodiment may be incorporated in the image forming apparatus of Embodiment 3, similarly.

As described in the foregoing, according to this embodiment, the exchange of the photosensitive drum 1 of the image forming station with which the discharge current is large can be notified to the user, before the defect such as the image flow tends to occur because of the large difference in the discharge currents due to the difference in the amount of use, when the AC voltage source is common to the image forming stations.

### (Others)

The present invention is not limited to the specific structures of the above-described embodiments.

In the above-described embodiments, the AC voltage source for applying the charging AC voltage in the charging member is common for the yellow, magenta and cyan image forming stations. However, this is not inevitable, and the present invention is applicable when a single AC voltage source is employed to apply the AC voltages to the charging members of the image forming stations, with the same advantageous effects. For example, the AC voltage source may be common to the yellow, magenta, cyan and black image forming stations.

In the above-described embodiments, the calculation and determination program is executed for determining the peak-to-peak voltage or the AC current of the charging AC voltage in the charging step of the printing step, during the printing preparation rotating operation period which is a non-image-formation period. The program may be executed another non-image-formation, that is, during the initial rotating operation, the sheet interval step, or during the post-rotation step, or during a plurality of non-image-formation periods.

In the above-described embodiments, the image forming apparatus uses the drum cleaning device. However, the present invention is applicable to a so-called cleanerless image forming apparatus in which a developing device carries out simultaneous development and cleaning without use of a drum cleaning device.

The photosensitive drum may be a direct injection chargeable type having a charge injection layer having a surface resistance of 10̂9-10̂14 Ωcm. Even if the charge injection layer is not used, the present invention is applicable when the charge transfer layer has the resistance within the above-described resistance range. In addition, the photosensitive drum may be an amorphous silicon photosensitive member having a volume resistivity of the surface layer of approx. 10̂13Ω.

In the above-described embodiments, as charging member is a roller type flexible contact charging member (charging roller). However, other material such as fur brush, felt or textile, or other configuration is usable. By combining various materials, proper elasticity, electroconductivity, surface property and durability can be provided.

The waveform of the AC voltage component (voltage component having periodically changing level) of the oscillating electric field applied to the charging member may be a sinusoidal wave, a rectangular wave, a triangular wave or the like. It may be a rectangular wave provided by rendering a DC voltage source ON and OFF periodically.

In the above-described embodiments, the image forming apparatus is an intermediary transfer type, but this is not inevitable in the present invention. In one type of the tandem type image forming apparatuses, a recording material carrying member is provided in place of the intermediary transfer member used in the image forming apparatus of the above-described embodiments, in which a toner image is transferred directly onto the recording material carried on recording material carrying member (direct transfer type). The recording material carrying member may be an endless belt. For example, in the full-color image forming operation, multi-color toner images is superimposedly transferred onto the recording material carried on recording material carrying member. Thereafter, the toner image on recording material is fixed on the recording material to provide a color image. The present invention is applicable to such a direct transfer type image forming apparatus, with the same advantageous effects. The present invention is applicable to such a direct transfer type image forming apparatus, with the same advantageous effects.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 197704/2011 filed Sep. 9, 2011 which is hereby incorporated by reference.

What is claimed is:

1. An image forming apparatus comprising:
a plurality of photosensitive members;
a plurality of charging members, provided for said photosensitive members, respectively, for electrically charging said photosensitive members by being supplied with charging voltages each comprising a component of a DC voltage and a component of an AC voltage;
an AC voltage source for outputting an AC voltage commonly applied to at least two of said charging members;
AC current measuring devices for measuring AC currents flowing into said at least two charging members, respectively; and
control means for controlling peak-to-peak voltages of the AC voltages applied to said at least two charging members from said AC voltage source,
wherein said control means calculates peak-to-peak voltages of the AC voltages required to provide a predetermined discharge current, from results of the measurements of said AC current measuring devices, and determines a maximum value of the required peak-to-peak voltages as a target value of a constant-voltage-control of the AC voltage applied to at least two charging members from said AC voltage source in an image forming operation.

2. An apparatus according to claim 1, wherein for each of said at least two charging members, said control means obtains a function Yα between a peak-to-peak voltage and an AC current measured by said AC current measuring device when an AC voltage having a peak-to-peak voltage not less than Vth×2 at each of at least two points and obtains a function Yβ between a peak-to-peak voltage and an AC current measured by said AC current measuring device when an AC voltage having a peak-to-peak voltage less than Vth×2 at at least one point, and determines the peak-to-peak voltage satisfying the following as the required peak-to-peak voltage,
Yα−Yβ=D
where D is the predetermined discharge current, and
Vth is a discharge starting voltage relative to said photosensitive member when a DC voltage is applied to said charging member.

3. An image forming apparatus comprising:
a plurality of photosensitive members;
a plurality of charging members, provided for said photosensitive members, respectively, for electrically charging said photosensitive members by being supplied with charging voltages each comprising a component of a DC voltage and a component of an AC voltage;
an AC voltage source for outputting an AC voltage commonly applied to at least two of said charging members;
AC current measuring devices for measuring AC currents flowing into said at least two charging members, respectively; and
control means for controlling peak-to-peak voltages of the AC voltages applied to said at least two charging members from said AC voltage source,
wherein said control means calculates AC currents required to provide a predetermined discharge current, from results of the measurements of said AC current measuring devices, and determines a maximum value of the required AC currents as a target value of a constant-current-control of the AC voltage applied to at least two charging members from said AC voltage source in an image forming operation.

4. An apparatus according to claim 3, wherein for each of said at least two charging members, said control means obtains a function Yα between a peak-to-peak voltage and an AC current provided by the peak-to-peak voltage outputted from said AC voltage source when an AC voltage having a peak-to-peak voltage not less than Vth×2 at each of at least two points and obtains a function Yβ between a peak-to-peak voltage and an AC current provided by the peak-to-peak voltage outputted from said AC voltage source when an AC voltage having a peak-to-peak voltage less than Vth×2 at at least one point, and determines the peak-to-peak voltage satisfying the following as the required peak-to-peak voltage,
Yα=Yβ+D
where D is the predetermined discharge current, and
Vth is a discharge starting voltage relative to said photosensitive member when a DC voltage is applied to said charging member.

5. An apparatus according to claim 1, further comprising rubbing operation executing means for executing an operation of rubbing a surface of said photosensitive member to be charged by said charging member, in which when there is a charging member which is other than said charging member for which the maximum value is calculated and in which the discharge current provided by the control with the target is larger than a predetermined level, and a humidity is higher than a predetermined humidity, said rubbing operation executing means executes the rubbing operation.

6. An apparatus according to claim 5, wherein an abrading material is supplied onto the surface of said photosensitive member to be rubbed.

7. An apparatus according to claim 1, further comprising notifying operation executing means for executing a prompting replacement of said photosensitive member to be charged by said charging member, in which when there is a charging member which is other than said charging member for which the maximum value is calculated and in which the discharge current provided by the control with the target is larger than a predetermined level, said notifying operation executing means executes the notifying operation.
